(19) United States
(12) Patent Application Publication
(10) Pub. No.: US 2019/0362278 A1
(43) Pub. Date: Nov. 28, 2019

(54) ORGANIZATION AND ASSET HIERARCHY FOR INCIDENT PRIORITIZATION

(71) Applicant: Guavus, Inc., San Jose, CA (US)

(72) Inventors: Atul Saraf, Noida (IN); Ankit Bhardwaj, Delhi (IN); Anupam Rastogi, San Ramon, CA (US)

(21) Appl. No.: 15/990,632

(22) Filed: May 26, 2018

(51) Int. Cl. G06Q 10/06

(52) U.S. Cl. CPC G06Q 10/0635; H04L 63/0236; G06Q 10/0633; G06Q 10/06316

(57) ABSTRACT

A method for prioritizing a security incident is described. The method includes determining a social graph of a plurality users in an organization. The method then proceeds to apply a first algorithm to the social graph to determine a dynamic organizational hierarchy. The method identifies a critical user community from a plurality of critical users in the dynamic organizational hierarchy. A plurality of security incidents are identified based on the dynamic organizational hierarchy by the prioritization analytics engine. Each security incident includes at least one of an alert, an event and an anomaly. The security incident is identified when a critical user is affected by the security incident by the prioritization analytics engine. The security incident is selected from at least one of a security alert, a security event, and a security anomaly.

### FIELD

The description generally relates to a derived organizational hierarchy and criticality of assets for prioritized incidents. More particularly, the description relates to the prioritization of incidents associated with a dynamically derived organizational hierarchy and a dynamic list of critical assets or the combination thereof.

### BACKGROUND

Traditional asset management employs static lists of critical users and assets, e.g., critical servers, which are difficult to maintain. By way of example and not of limitation, static user lists are difficult to maintain because new users are sporadically included in the lists of user status. Additionally, critical asset lists, which may include critical servers or workstations, are even more difficult to maintain because of frequent changes to the Information Technology infrastructure.

The management of static lists is a problematic endeavor that usually requires external audits. For example, new users and devices are manually added to the asset management program during sparse revision cycles. Meanwhile, users leaving the corporate network are removed once their responsibilities have been fully transferred to a new employee (e.g., legacy projects and hard-coded access controls).

Another problem is the static representation of an organizational hierarchy that allows legacy accounts to be reused for months or years depending on a particular dependency that has been left on the tail of commits, checklists or documentation. Information technologies that depend on an unsupervised organizational hierarchy could compromise the confidentiality, integrity, and availability of the network operations. Thus, the problem of internal threats that maintain access to a group of systems exists even after their departure from an organization.

The critical infrastructure protection (CIP) standard for creating and identifying critical assets and related cyber systems rely on a prescriptive set of rules that is inflexible and would not adapt well in dynamic networks composed of dispersed geographical locations, cloud computing services, network assets, data sources, IoT devices, and personal devices (e.g., BYOD).

Risk management programs depend on borrowed frameworks from other areas, e.g., energy, for asset identification, audits, and manual catalogs of critical assets. Further aggravating the problem is the uniqueness of a corporate network, which does not operate within a rigid framework among distributed organizations. As a result, the implementation of inflexible frameworks in dynamic networks for critical asset identification would eventually degrade into substandard versions and inferior implementations from the original standard.

In addition, a problem with traditional Security Operation Centers (SOC) is the volume of threat intelligence data, and unprioritized number of alerts, events, and anomalies. In this situation, cybersecurity analysts must identify, protect, detect, and respond to a massive number of incidents on the network including false positives and obsolete threat scoring systems. Moreover, traditional threat scoring systems are inadequate in a growing, dynamic, and polymorphic network of devices and users.

Threat scores are one component of asset management, vulnerability assessments, governance, risk assessments, and compliance. Thus, identification, prevention, protection, detection, response, and mitigation actions require different and dynamic prioritizations.

It would, therefore, be beneficial to provide flexible security management systems and methods that prioritize incidents based on an independent and dynamic set of user attributes and asset parameters.

### SUMMARY

A method for prioritizing a security incident is described. In one illustrative embodiment, the method includes determining a social graph of a plurality of users in an organization. The method then proceeds to apply, at a prioritization analytics engine, a first algorithm to the social graph to determine a dynamic organizational hierarchy. The prioritization analytics engine then identifies a critical user community from a plurality of critical users in the dynamic organizational hierarchy. A plurality of security incidents are identified based on the dynamic organizational hierarchy by the prioritization analytics engine. In the illustrative embodiment, each security incident includes at least one of an alert, an event and an anomaly. At least one security incident is identified when a critical user is affected by the security incident by the prioritization analytics engine. The security incident is selected from at least one of a security alert, a security event, and a security anomaly. At least one of a security incident is reported, when there is a potential impact to at least one critical user.

In the illustrative embodiment, the social graph is generated with at least one email communication log. By way of example and not of limitation, the first algorithm includes a betweenness algorithm.

In another embodiment, a critical asset community is identified from a plurality of data sources and from the critical user accessing the data sources. In the illustrative embodiment, the data sources include at least one network device accessing at least one of a firewall log and a router log. Additionally, at least one of the security incident is identified when at least one critical asset in the critical asset community is affected by the security incident that is selected from at least one of the security alert, the security event, and the security anomaly. Each security incident is prioritized based on the security incident affecting the critical asset accessed by the critical user. At least one security incident is reported based on a potential impact to at least one critical asset.

In another illustrative embodiment, a method for prioritizing a security incident is described. The method includes determining, at a prioritization analytics engine, a dynamic organizational hierarchy. The method then applies a first algorithm to the organizational hierarchy to produce a dynamic order of critical assets at the prioritization analytics engine. A critical asset community is identified from a plurality of critical assets in the network. The method then proceeds to prioritize a plurality of security incidents based on the dynamic order of critical assets. In the illustrative embodiment, each security incident includes at least one of a security alert, an event and an anomaly. The prioritization analytics engine prioritizes at least one security incident when a critical asset is affected by the security incident. In the illustrative embodiment, the security incident is selected from at least one of a security alert, a security event, and a security anomaly. The method then reports at least one of a security incident when there is a potential impact on at least one critical asset.

In the illustrative embodiment, the dynamic order of critical assets is generated with network access logs and at least one dynamic organizational hierarchy. The algorithms may include clustering and baselining using the access pattern of users weighted by hierarchy rank.

In another illustrative embodiment, the method identifies a critical asset community from a plurality of data sources and from the critical user accessing the data sources. The data sources include at least one network device accessing at least one of a firewall log and a router log. The method prioritizes each security incident that affects the critical asset accessed by the critical user. Additionally, the dynamic organization hierarchy may be generated with a social graph.

### DRAWINGS

The present subject matter will be more fully understood by reference to the following drawings which are presented for illustrative, not limiting, purposes.

FIG. 1 shows an on-premise network architecture for a derived organizational hierarchy and criticality of assets for prioritized incidents.

FIG. 2A and FIG. 2B show a network architecture based on cloud computing services for a derived organizational hierarchy and criticality of assets for prioritized incidents.

FIG. 3 shows the priority of incidents for users and network assets.

FIG. 4A and FIG. 4B show an illustrative flowchart of a derived organizational hierarchy and criticality of assets for prioritized incidents.

FIG. 5 shows a prioritization analytics engine.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. Additionally, the methods may vary as to details, order of the actions, or other variations without departing from the illustrative methods disclosed herein.

A system and method for dynamically identifying critical users and critical assets for incident prioritization is described herein. In the illustrative embodiments, the illustrative incidents are ranked based on user importance and the criticality of assets. Note, for purposes of this patent the terms “incident” and “security incident” are used interchangeably, unless there is a further distinction based on the context.

A “security incident” is defined as a suspicious alert, event, or anomaly that attempts to compromise the confidentiality, integrity, and availability of a user, an asset or both. A severity incident classification system is provided to quantify the impact on the business and network operations. The impact levels include but are not limited to catastrophic, major, moderate, minor, and insignificant.

A “high-security incident” includes impact levels of moderate to catastrophic consequences. In addition, a high-security incident is defined in terms of a high-security alert, high-security event, or high-security anomaly. As a result, incident prioritization occurs when an alert, event, or anomaly is escalated to the next level on the basis of rank of the user (importance) and rank of assets (criticality) involved.

Critical assets are defined as the plurality of network and computing devices employed by critical users during a specific period. Critical assets are tagged using the access pattern of critical users and the relative importance of critical users accessing those assets.

In the illustrative embodiments presented herein, security incidents are dynamically prioritized using the importance of users. Additionally, security incidents described herein are prioritized based on access patterns corresponding to the rank or importance of the users and the rank or criticality of the assets.

The system and method for dynamically identifying critical users and critical assets for incident prioritization rely on the relative importance of the user, i.e., critical user, within an organizational hierarchy.

An organization is defined as a group of people with the same purpose or goal operating under a social structure. Furthermore, the organizational hierarchy includes a social graph that represents personal relations and status among users. In addition, the organizational hierarchy is a global mapping of members and their status in the organization.

Organizational hierarchies may be determined from organizational communication tools. Organization communication tools are, generally, embodied as software operating on networked hardware such as mobile phones, network laptop, networked personal computers and other such devices that may be used by employees or contractors to communicate within the organization. The illustrated software modules, software components, software applications or other such software systems are configured to support communications within the illustrative organization hierarchy. For example, illustrative organizational tools include email communications, chat-based communications, voice communications, video communications and other such organizational communications tools.

In the illustrative embodiment, email communications are used to develop a social graph; and the social graph is then used to determine the organizational hierarchy. Social graphs are mathematical representations of interconnected social networks based on logged user interactions. A typical channel for user interaction is email messages due to popularity, availability, inbox size, and reliability. In addition, email is a prerequisite for many social media platforms.

The social graph is used to depict relationships between users and to help identify the organizational hierarchy. Initially, the interacting entities or users become a node in the construct of a social graph.

Additionally, the social graph may be used to provide a mapping of users and how the users are related. By way of example and not of limitation, social graphs as presented herein may be designed with relevant features from email communications. More specifically, email communications are used to generate a social graph, which is then used to identify the derived organizational hierarchy.

The illustrative systems and methods presented herein collect event data in real time at massive scale from a variety of sources, e.g., device logs, email logs, router logs, firewall logs, leveraging data at rest, data lakes, and data in motion. The data is enriched with functional data in real time with other events and references by combining data in motion and data at rest. A prioritization analytics engine as described in further detail below is used to ingest a plurality of data sources and apply analytic algorithms for prioritizing security incidents.

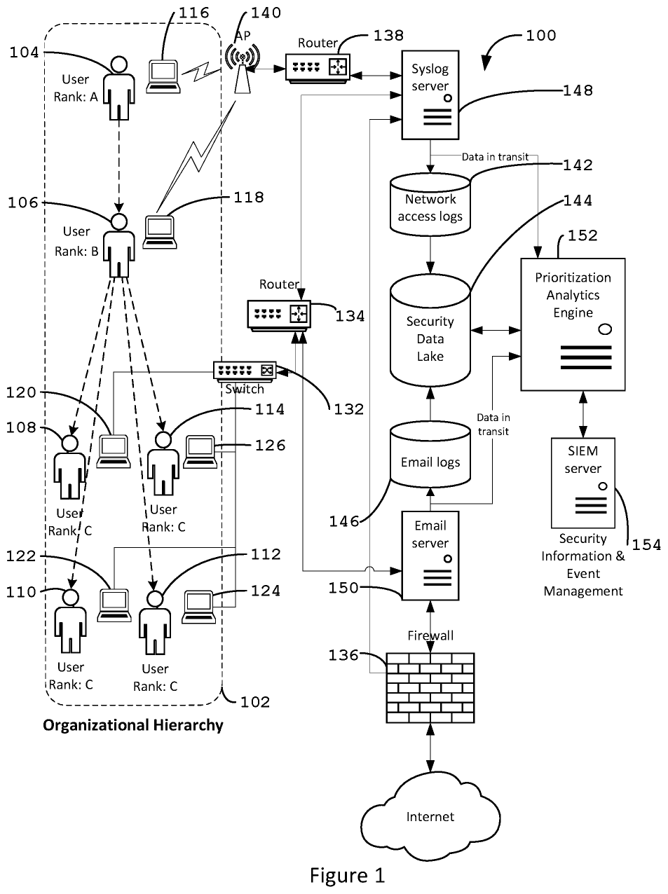

Referring to FIG. 1, there is shown an illustrative on-premise network system 100 that derives an organizational hierarchy and identifies critical users and critical assets. In the illustrative embodiment, the Organizational Hierarchy 102 includes a User Rank: A 104. By way of example and not of limitation, User Rank: A 104 is a high-ranking member of the organization, which is also referred to as a “critical user.”

An illustrative User Rank: B 106 reports to User Rank: A 104. Additionally, User Rank: B 106 manages a team of users illustrated as User Rank: C 108, User Rank: C 110, User Rank: C 112, and User Rank: C 114. Thus, User Rank: B 106 may also be identified as a critical user. Consequently, User Rank: A 104 and User Rank: B 106 may form a group of critical users that are associated with a critical user community. The non-critical users have a User Rank: C.

In the illustrative Organizational Hierarchy 102, an illustrative chain of command exists, in which User Rank: B 106 relays information between User Rank: A and regular users, e.g., employees of Rank: C. The illustrative users may include employees, members, subscribers and other such persons affiliated or associated with the organization. By way of example and not of limitation, each of the users 104, 106, 108, 110, 112, and 114 interact with computing devices 116, 118, 120, 122, 124, and 126, respectively.

Computing devices 116, 118, 120, 122, 124, and 126 constitute a plurality of devices having a user interface, network interface, memory, storage, and a processor which are not shown in the illustrative FIG. 1. A user interface consists of any mechanism to interact with a computing device such as a Graphical User Interface (GUI) displayed on a high-resolution display. The “network interface” establishes a communication link between the user device and a network asset.

In the illustrative embodiment, all users in the Organizational Hierarchy 102 collaborate through e-mail messages that are stored by an illustrative email server 150, which includes at least one stored email communication log. By way of example and not of limitation, an email communication log is used to generate a social graph. As previously stated, the social graph is used to depict relationships between users and to help identify the organizational hierarchy. The illustrative of users 104, 106, 108, 110, 112, and 114 generate email communication logs that are used to for determining the social graph.

Each of the computing devices 116, 118, 120, 122, 124, and 126 is connected to a network, in which the network has the ability to send emails through monitored network devices or network assets. Note, that for purposes of this patent, terms such as “network devices” may also be referred to interchangeably as “network assets.” Additionally, with respect to information security, computer security, and network security, an “asset” is any data, device, or another component of the environment that supports information-related activities. Furthermore, the network assets may include wired network assets and wireless network assets.

The illustrative wired network assets include physical mediums of transmission such as fiber optic cable or ethernet cable. Further still, the illustrative wired network assets include any network asset capable of establishing and terminating logical links between clients such as switch 132, router 134 and 138, and firewall 136.

The wireless network assets include a plurality of computing devices capable of supporting wireless protocols, e.g., 802.11 a/n/ac and 802.11 ad, in the 2.4, 5.0, and 60 GHz wireless range. An illustrative wireless router 138 with an Access Point (AP) 140 is typically employed to provide wireless access to authorized users on a typical network.

It shall be appreciated by those of ordinary skill in the art that each of the computing devices 116, 118, 120, 122, 124, 126, switch 132, AP 140, router 134 and 138, and firewall 136 and other network assets may include a processor (not shown) and memory (not shown).

In the illustrative embodiment, the computing units 116 and 118, router 138 and AP 140 have been identified as critical assets. The illustrative wired computing units 120, 122, 124, and 126, router 134, and switch 132 are lower ranking or less critical assets, which may also be accessed by the critical users.

Network logs are generated by the network assets. For example, the network logs from switches 132, AP 140, routers 134 and 138, and firewalls 136 are collected by illustrative storage repository that includes, but are not limited to, network access logs 142, security data lake 144, and email logs 146. Each storage repository 142, 144 and 146 is capable of storing large amounts of raw data. Storage is a device capable of storing, porting and extracting large data files and massive objects. The storage device can reside internally or externally on a computing device.

With respect to illustrative firewall 136, the firewall 136 may be configured to operate as an appliance capable of packet filtering, deep packet inspection (DPI), intrusion detection system (IDS), and intrusion prevention system (IPS). Packet filtering is a set of rules allowing or denying traffic based on Internet Protocol (IP) address, protocol, and port. A deep packet inspection (DPI) system is also called a complete packet inspection and information extraction system. A DPI operates at the application layer of the Open System Interconnection (OSI) model allowing to search for nonconforming protocols, spam, malware, pattern matching, data mining. An intrusion detection system (IDS) is a software or hardware application that can detect malicious activity through signature-based detection or anomaly-based detection. Signature-based detection depends on a malware repository of digital signatures. Meanwhile, anomaly-based detection relies on machine learning to detect deviations from the norm. Lastly, an intrusion prevention system (IPS) incorporates the features of an IDS with reactive capabilities (e.g., terminating a malicious connection).

The illustrative network system 100 also includes a logging unit defined as Syslog server 148, which processes alerts, events, and anomaly messages from network devices. Syslog is a computing standard for message logging. The Syslog protocol allows network assets to generate, store, report, and analyze messages using a modular architecture. The majority of network assets use the Syslog standard to aggregate logging data from different sources into storage repositories such as network access logs 142 and security data lake 144.

The illustrative network system 100 also includes an email server 150, which is used to send and receive email. Additionally, the illustrative email server 150 can support transmission protocols such as Simple Mail Transfer Protocol (SMTP) and incoming protocols such as Internet Message Access Protocol (IMAP) and Post Office Protocol (POP3). The email server 150 can also be configured to store the email logs in storage repository 146.

The network access logs 142 and email logs 146 are a communicatively coupled to a security data lake 144, which provides massive data to a prioritization analytics engine 152. The prioritization analytics engine 152 prioritizes incidents associated with a dynamically derived organizational hierarchy and a dynamic list of critical assets or the combination thereof.

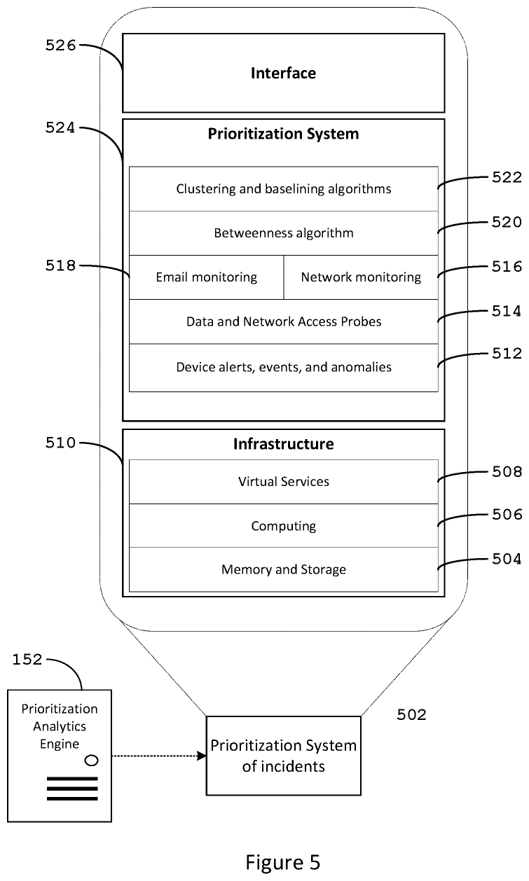

The prioritization analytics engine 152 may also directly communicate with security data sources such as network access logs storage repository 142, security data lake 144, and email log repository 146 for scoring alerts, events, and anomalies. The prioritization analytics engine 152 includes a prioritization system described in further detail in FIG. 5.

The illustrative network system 100 also includes an illustrative Security Information and Event Management (SIEM) server 154, which provides real-time incidents reported by the prioritization analytics engine 152. A SIEM is the combination of a Security Information Management (SIM) system and a Security Event Management (SEM) system that provides real-time visibility of security incidents generated by users and assets. The capabilities provided by the SIEM include, but are not limited to, data aggregation, real-time monitoring, correlation of events, notification, alerting, vulnerability management, policy compliance, data gathering, data analysis, data manipulation, data visualization, and forensic analysis. By way of example and not of limitation, the derived organizational hierarchy and a dynamic list of critical assets are computed by the prioritization analytics engine 152 for SIEM 154 consumption.

In operation, the prioritization analytics engine 152 performs a scoring of security alerts, events, and anomalies based on user hierarchy and asset importance. Additionally, the application residing in the prioritization analytics engine 152 determines connections in social graphs from network access logs 142, security data lake 144, and email logs 146.

By way of example and not of limitation, the prioritization analytics engine 152 is configured to utilize a variety of algorithms. For example, the prioritization analytics engine 152 may be configured to use the “betweenness” algorithm to dynamically determine the organizational hierarchies in the organization and rank employees based on their importance.

In social network theory, the betweenness algorithm represents the degree of which users stand between each other. For instance, a user with higher betweenness centrality would have more control over the hierarchy, because more information is relayed through that particular user. Users with high betweenness have a considerable impact on the social network by virtue of their authority over the quantity and quality of information passing between members of the organizational hierarchy. Thus, removing a critical user from the organizational hierarchy would have the most impact on the social network. In operation, the dynamic application of a betweenness algorithm by the prioritization analytics engine 152 to each node of users 104, 106, 108, 110, 112, and 114 results in updates of organizational hierarchies within the population.

The components that may be utilized by the prioritization analytics engine 152 include clustering and baselining algorithms. In the illustrative embodiment, clustering and baselining allow the creation of dynamic lists of critical assets using the access pattern of user accounts weighted by user rank in the organizational hierarchy.

Clustering and baselining are components of the invention for grouping users into profile-based clusters using network usage as the metric in the organizational hierarchy. The system and method perform continuous baselining to determine the normal behavior of data flow, users, and servers. The system and method described are capable of identifying changes in normal behavior which trigger the SIEM module to determine the cause of the issue.

The analytics components derive correlations between logs from a plurality of network assets. Furthermore, the features, characteristics, and behaviors of the network assets are aggregated in term of sameness. Equally important, the prioritization analytics engine is capable of determining relationships between nodes gaining real-time knowledge of the physical and logical topology of the network.

The system and method provide the ability to inspect packet flow from subscribers to various network assets. Additionally, the prioritization analytics engine is instructed to learn normal behavior based on time periods including days, weeks, months, and years. Furthermore, the prioritization analytics engine is capable of anomaly detection and reporting, further reducing the rate of false positives.

Thus, the clustering and baselining algorithms are used to determine the access patterns from the network users. As a result, incidents are prioritized based on the rank of users (relative importance) and rank of assets (criticality).

By way of example and not of limitation, the email tracking fields used to develop organizational hierarchies include content, timestamp, client IP, client hostname, server IP, server hostname, source context, connector identifier, message tracking events (ADMIN, AGENT, DSN, GATEWAY, PICKUP, ROUTING, SMTP, STOREDRIVER), event identifier, internal message identifier, message identifier, recipient addresses, recipient status, message total bytes, recipient count, related recipient addresses, type of event (DSN, SEND, TRANSFER), message subject, sender address, return e-mail address, and other message information.

By way of example and not of limitation, standard fields provided by next-generation firewalls 240 that are used to develop organizational hierarchies may include the server name, timestamp, transport protocol, client IP and port, destination IP and port, original client IP, source network, destination network, type of action, error codes, active firewall rule, application protocol, bidirectional communication flag, bytes sent, bytes received, processing time, destination hostname, client username, client agent, session identifier, connection identifier, network interface, raw IP header, raw payload, NAT address, and other vendor-specific fields.

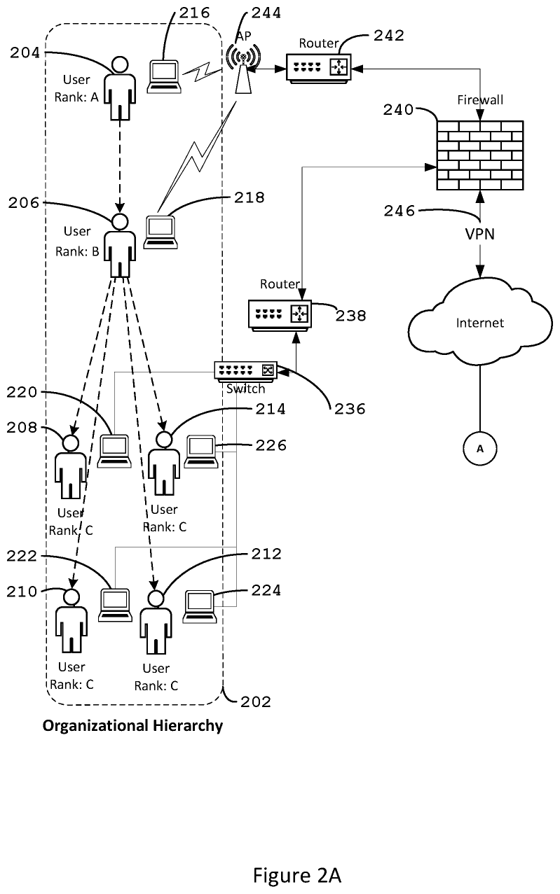

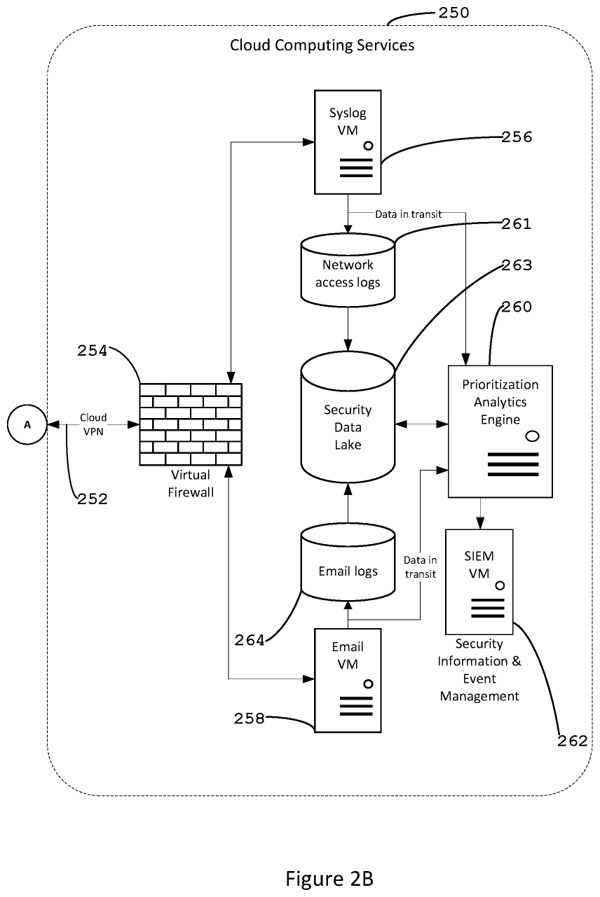

Referring now to FIG. 2A and FIG. 2B, there is shown a system for prioritization of security incidents using cloud computing services. Cloud computing allows for provisioning of leased system resources and high-level services through an Internet connection. Cloud computing may include an application, a platform (e.g., operating system, identity, object storage, databases), and an infrastructure (e.g., computing, block storage, network) which service a plurality of user devices such as servers, laptops, desktops, tablets, smartphones, IoT, wearables, and other devices connected over the cyberspace.

Although the organizational hierarchy and network devices operate in a manner similar to the elements shown in FIG. 1, the prioritization of security incidents may be performed remotely in a manner as described below.

In FIG. 2A, a plurality of users of organizational hierarchy 202 is shown that users (e.g., employees, members, subscribers) 204, 206, 208, 210, 212, and 214 belong to an organizational hierarchy 202. The users 204, 206, 208, 210, 212, and 214 also interact with computing devices 216, 218, 220, 222, 224, and 226, respectively.

The network assets include wired network assets and wireless network assets such as wired network assets that include switch 236, router 238, and firewall 240. The wireless network assets include router 242 with an Access Point (AP) 244.

In a distributed organizational system, a network of remote users, regional offices, and head offices are connected through a Virtual Private Network (VP N) 246 including cloud-based VPN technologies. A Virtual Private Network (VPN) is an encrypted tunnel established between a remote user, a regional office or a head office. In the illustrative embodiments shown in FIGS. 2A and 2B, the encrypted tunnel provides security and privacy through an authenticated connection established between firewall 240 and a remote virtual firewall 254 hosted in a cloud computing service.

Referring now to FIG. 2B, there is shown an illustrative cloud computing system 250. Additionally, a plurality of virtual machines (VMs) may be hosted on a cloud computing environment. A Virtual Machine (VM) is a software computer running an operating system, applications, and services commonly executed on a physical computer. A virtual device offers the same functionality as the physical device with additional benefits of portability, management, and security.

The illustrative cloud system 250 of FIG. 2B may be embodied as one of four fundamental cloud service models, namely, infrastructure as a service (IaaS), platform as a service (PaaS), software as a service (SaaS), and network as a service (NaaS).

Infrastructure as a service (IaaS) is the most basic cloud service model. IaaS providers offer VMs and other resources. The VMs also referred to as “instances,” are run as guests by a hypervisor. Groups of hypervisors within the cloud operational support system support large numbers of VMs and the ability to scale services up and down according to customers' varying requirements. IaaS clouds often offer additional resources such as images in a virtual machine image library, raw (block), object, and file-based storage, firewalls, load balancers, IP addresses, virtual local area networks (VLANs), and software bundles. IaaS cloud providers supply these resources on demand from their large pools installed in data centers. For wide area connectivity, the Internet can be used, or virtual private networks (VPNs) can be used.

Platform as a service (PaaS) enables cloud providers to deliver a computing platform that may include an operating system, a programming language execution environment, a database, and a web server. Application developers can develop and run their software solutions on the PaaS without the cost and complexity of buying and managing the underlying hardware and software layers. With some PaaS solutions, the system resources scale automatically to match application demand, so the cloud end user does not have to allocate resources manually.

Software as a service (SaaS) enables cloud providers to install and operate application software in the cloud. Cloud end users access the software from cloud clients. The cloud end users do not manage the cloud infrastructure and platform that runs the application. The SaaS application is different from other applications because of scalability. Scalability can be achieved by cloning tasks onto multiple VMs at run-time to meet the changing work demand. To accommodate a large number of cloud end users, cloud applications may be multitenant and serve more than one cloud end-user organization. Some SaaS solutions may be referred to as desktop as a service, business process as a service, test environment as a service, communication as a service.

The fourth category of cloud services is Network as a service (NaaS), in which the capability provided to the cloud computing service end user is to use a network/transport connectivity services, an inter-cloud network connectivity services, or the combination of both. NaaS involves the optimization of resource allocations by considering network and computing resources as a unified whole, and traditional NaaS services include flexible and extended VPN and bandwidth on demand.

There are different types of cloud deployment models for cloud computing services 250, which include a public cloud, a community cloud, a hybrid cloud, and a private cloud. In a public cloud, applications, storage, and other resources are made available to the general public by a service provider. These services are free or offer a pay-per-use model.

The community cloud infrastructure is used by several organizations from a community with shared concerns and can be managed internally or by a third-party and hosted internally or externally. Therefore, the costs are spread over fewer users than a public cloud (but more than a private cloud).

The private cloud infrastructure is operated solely for a single organization, whether managed internally or by a third-party and hosted internally or externally. A private cloud project requires virtualizing the business environment, and it requires that the organization reevaluate decisions about existing resources.

The hybrid cloud is a composition of two or more clouds (private, community or public) that remain unique entities but are bound together, offering the benefits of multiple deployment models. Hybrid cloud architecture requires both on-premises resources and off-site (remote) server-based cloud infrastructure. Although hybrid clouds lack the flexibility, security, and certainty of in-house applications, the hybrid cloud provides the flexibility of in-house applications with the fault tolerance and scalability of cloud computing services.

The cloud computing service includes the cloud-based VPN 252 and virtual firewall 254. The virtual firewall 254 includes a virtualized service offering of packet filtering, deep packet inspection (DPI), intrusion detection system (IDS), and intrusion prevention system (IPS).

In addition, a security data lake 263 is used to store large amounts of raw data of network access logs 261, email logs 264, and other network asset feeds. The VMs provide a platform for a Syslog VM 256, an email services VM 258, a prioritization analytics engine VM 260, and security information and event management (SIEM) VM 262. Each of the VMs operate in a manner similar to the engines and serves described in FIG. 1, except the VMs are configured to operate as a cloud-based system.

Additionally, the cloud computing-based system 250 may include other VMs (not shown) that provide operating systems, applications, and services, which include feature extraction, access patterns, and prioritization of security incidents.

Referring now to FIGS. 2A and 2B, the users 204, 206, 208, 210, 212, and 214 in an organizational hierarchy 202 are continuously monitored for internal network access of assets. By way of example and not of limitation, network services provided to users are logged from devices including, but not limited to, computing devices 216, 218, 220, 222, 224, and 226, switches 236, routers 238 and 242, access points 244, and firewalls 240.

In the illustrative embodiment, one or more social graphs are dynamically generated using the email features reported by an email server 258 and email logs 264. In the illustrative embodiments, a social graph is generated from email communication logs. Dynamic social graphs are designed with relevant features from email communication logs to create the derived organizational hierarchy.

The system and method determine the important users and critical assets dynamically. The prioritization analytics engine 152 (shown in FIG. 1) and 260 may incorporates algorithms that manage new members and employees leaving the organization. The illustrative algorithms include, but are not limited to the betweenness, clustering, and baselining algorithms. A dynamic method to discover critical assets may be used, in which the critical assets are determined by the number of users accessing the asset and the relative importance of the users accessing the network services.

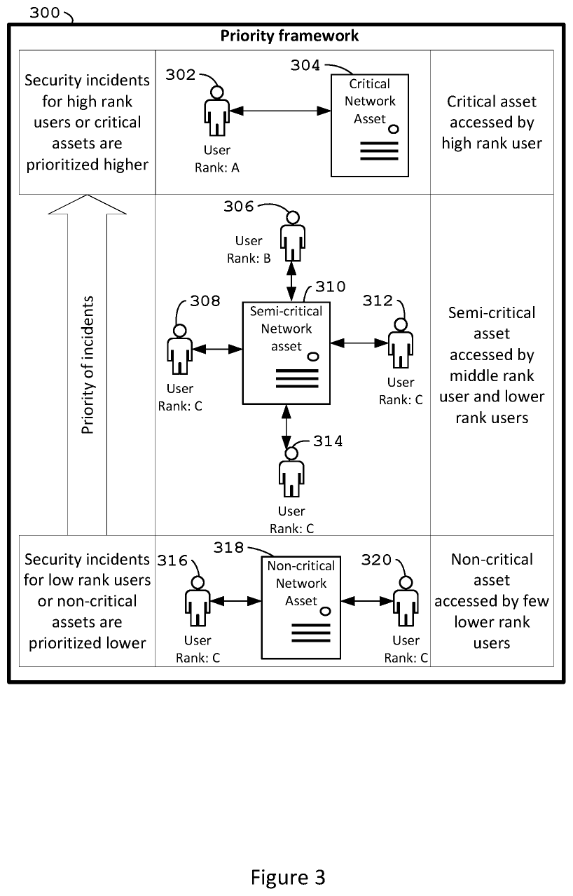

Referring now to FIG. 3 there is shown a priority framework 300 for user and asset interactions. More specifically, the functionality provided by prioritized incidents can be further explained with priority framework 300.

For example, User Rank: A 302 (a critical user) accesses a critical asset 304, which may result in a high-security incident. Security incidents for high-rank users or critical assets are prioritized higher. The priority framework 300 shows a high-security incident with impact levels having moderate to catastrophic consequences. The high-security incident includes a high-security alert, high-security event, or high-security anomaly.

Equally important are semi-critical assets 310 accessed by middle-rank user B 306 and User Rank: C 308, User Rank: C 312, and User Rank: C 314. The middle-rank user will produce a score priority between high and low. Thus, the priority of incidents increases positively with the importance of a user and criticality of an asset when factored into the alert, event or anomaly.

By comparison, security incidents for low-rank users or non-critical assets are prioritized lower. For instance, User Rank: C 316 and User Rank: C 320 accessing a non-critical asset yield a lower priority. The security incidents for low-rank users or non-critical assets are prioritized lower.

In operation, incident prioritization occurs when an alert, event, or anomaly is escalated to the next level on the basis of rank of the user (importance) and rank of assets (criticality) involved.

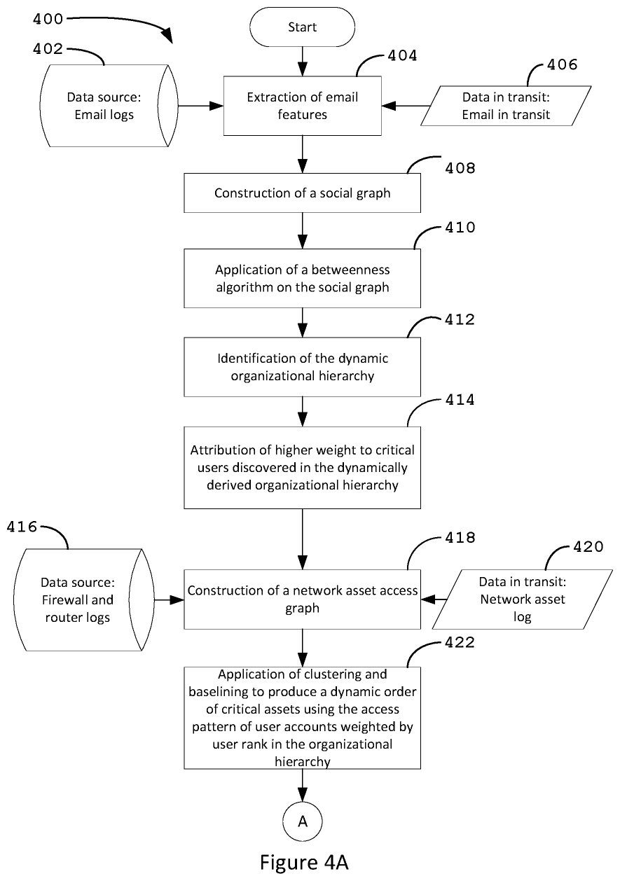

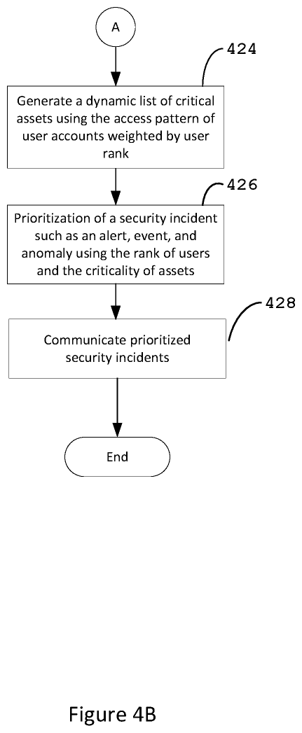

Referring to FIG. 4A and FIG. 4B, there is shown an illustrative flowchart 400 of a method to prioritize security incidents. The flowchart described in FIG. 4A and FIG. 4B represents an illustrative flow of feature extraction, social graph construction, analytics algorithms, and dynamic derivation of organizational hierarchy and critical assets for prioritization of security incidents.

In the illustrative method 400, a data source 402 that includes historical email logs are provided and used as input for feature extraction by process 404. Additionally, the feature extraction process may be performed for real-time information that is generated by data in transit such as real-time email logs 406. At block 404, feature extraction from email logs 402 determines the model constructs and baselining for the generation of the social graphs, which is performed at block 408.

By way of example and not of limitation, the operations associated with steps 404 and 408 are performed at the prioritization analytics engine 152 or prioritization analytics engine 260. However, the social graphs may be generated by a separate component such as a social graphing module.

The social graph 408 is a graph-relational view of users. Social graphs are mathematical representations of interconnected social networks based on logged user interactions as described above. Social graphs are dynamically generated using the email features reported by the illustrative email servers 150 and 258 (e.g., Exchange).

The method then proceeds to block 410 where a betweenness algorithm and social graphs are used to identify the organizational hierarchies 412. The betweenness algorithm illustrated in this embodiment may also defined as a centroid-based clustering algorithm. The betweenness algorithm represents the degree of which users stand between each other. Therefore, a user with higher betweenness centrality would have more control over the hierarchy, because more information is relayed through that particular user. As described above, users with high betweenness have a considerable impact on the social network by virtue of their authority over the quantity and quality of information passing between members of the organizational hierarchy. As described above, a higher weight is given to important users discovered in the dynamically derived organizational hierarchy 414. In the illustrative embodiment presented herein, the operations performed at blocks 410, 412 and 414 are performed at the prioritization analytics engine 152 or prioritization analytics engine 260.

Proceeding to block 418, a network asset access graph may be constructed from a plurality of sources such as data in transit, data at rest, and data lakes. For example, the network access graph may be constructed with data from assets such as firewall logs and router logs 416 and real-time network logs 420.

At block 422, the importance of network assets is measured. By way of example and not of limitation, analytics modules using clustering and baselining algorithms generate a dynamic order of critical assets using the access pattern of user accounts weighted by user rank in the organizational hierarchy. Clustering and baselining are used to order the assets regarding a number of users and rank of users. Critical assets receive more connections from a broader community of critical users. Thus, a dynamic list of critical assets using the access pattern of user accounts weighted by user rank is generated in block 424. In the illustrative embodiment presented herein, the operations performed at blocks 418, 422 and 424 are performed at the prioritization analytics engine 152 or prioritization analytics engine 260.

The method then proceeds to block 426 where prioritization is accomplished using two dynamically determined data sets from blocks 414 and 424 defined as the rank of users and criticality of assets. At block 426, the method proceeds by prioritizing a security incident such as an alert, event, and anomaly using the rank of users 412 and the criticality of assets 424.

At block 428, the prioritized security incidents affecting the critical users are communicated to the appropriate system, service, organization, individual or other such entity. Additionally, security incidents based on a potential impact to at least one critical asset are also reported.

A distinction may be drawn between a “security incident” and a “high-security incident” depending on the type of illustrative alert, event, or anomaly. In the illustrative embodiment presented herein, the operations performed at blocks 426 and 428 are performed at the prioritization analytics engine 152 or prioritization analytics engine 260.

Referring to FIG. 5, there is shown an illustrative prioritization analytics engine 152 (shown in FIG. 1), which provides a prioritization system of incidents 502. The illustrative prioritization analytics engine 152 or 260 (shown in FIG. 2B) includes an infrastructure component 510, a prioritization system 524, and an interface 526. The infrastructure component 510 includes the bulk of hardware components required to support the efficient operation of the prioritization analytics engine 152. The prioritization system 524 includes the modules and architecture required to generate prioritized security incidents. The interface 526 represents the presentation layer of the prioritization analytics engine 152 which could be implemented as an Application Programming Interface (API).

In this illustrative embodiment, the infrastructure component 510 includes a memory or storage 504, a computing processor 506, and one or more illustrative virtual services 508. Memory is defined as a physical device used for fast access to volatile and non-volatile data. Memory is employed as a source of primary data used by the processor or computing element for program execution.

The prioritization system 524 is configured to perform email monitoring 518 and network monitoring 516 as described above. The illustrative prioritization system 524 may also access additional data repositories that include, but are not limited to, big data and network access probes 514 as described above. The prioritization system 524 may also be configured to apply various analytic components such as clustering and baselining 522 and a Betweenness module 520. Operations and prioritization are performed on device alerts, events, and anomaly detection 512 as described above.

The prioritization analytics engine is communicatively coupled to the network as described above. For the cloud service embodiment, the prioritization analytics engine may be embodied as a Virtual Machine (VM) that is running on a processor and memory.

Additionally, security solutions such as a Security Information and Event Management (SIEM) would benefit from prioritized incidents based on user importance and critical assets. Effectively, the attention of security experts would be directed towards the critical aspects of cybersecurity operations.

The dynamic nature of the systems and methods presented herein overcomes the limitations of static lists of organizational hierarchies and network assets based on sparse site surveys. As a result, the illustrative systems and methods provide a dynamic method to prioritize security incidents on a dynamic network of users and devices.

This systems and methods described above use logged email communications to determine the organizational hierarchies and identify important users using social graphs. An illustrative system and method for dynamically deriving the organizational hierarchy in the organization to rank users have been described. Also, a system and method of generating a dynamic list of critical assets for prioritized security incidents are described. The systems and methods described herein rely on the degree of interconnections among users so that important users are critical nodes of communication among geographical locations, departments, workgroups, and teams.

In the illustrative embodiments presented, organizational hierarchies, and lists of critical assets are determined dynamically and automatically. Additionally, analytics algorithms, e.g., betweenness algorithm, are used to continuously add new members, update existing members, and remove members leaving the network. Furthermore, the application of clustering and baselining allows for the creation of dynamic lists of critical assets using the access pattern of user accounts weighted by rank or status in the organizational hierarchy.

It is to be understood that the detailed description of illustrative embodiments is provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A method for prioritizing a security incident, the method compromising:
determining a social graph of a plurality users in an organization;
applying, at a prioritization analytics engine, a first algorithm to the social graph to determine a dynamic organizational hierarchy;
identifying, at the prioritization analytics engine, a critical user community from a plurality of critical users in the dynamic organizational hierarchy;
prioritizing, at the prioritization analytics engine, a plurality of security incidents based on the dynamic organizational hierarchy, wherein each security incident includes at least one of an alert, an event and an anomaly;
identifying, at the prioritization analytics engine, at least one security incident when a critical user is affected by the security incident, wherein the security incident is selected from at least one of a security alert, a security event, and a security anomaly; and
reporting at least one of a security incident when there is a potential impact to at least one critical user.

2. The method of claim 1 wherein the social graph is generated with at least one email communication log.

3. The method of claim 1 wherein the first algorithm includes a betweenness algorithm.

4. The method of claim 1 further comprising identifying a critical asset community from a plurality of data sources and from the critical user accessing the data sources.

5. The method of claim 4 wherein the data sources include at least one network device accessing at least one of a firewall log and a router log.

6. The method of claim 4 identifying at least one of the security incident when at least one critical asset in the critical asset community is affected by the security incident that is selected from at least one of the security alert, the security event and the security anomaly.

7. The method of claim 6 further comprising prioritizing each security incident that affects the critical asset accessed by the critical user.

8. The method of claim 7 further comprising reporting at least one security incident based on a potential impact to at least one critical asset.

9. A method for prioritizing a security incident, the method compromising:
determining, at a prioritization analytics engine, a social graph of a plurality of users in an organization;
applying, at the prioritization analytics engine, a first algorithm to the social graph to determine a dynamic organizational hierarchy;
identifying, at the prioritization analytics engine, a critical user community from a plurality of critical users in the dynamic organizational hierarchy;
identifying, at the prioritization analytics engine, a critical asset community from a plurality of data sources and from the critical user accessing the data sources
prioritizing, at the prioritization analytics engine, a plurality of security incidents based on the dynamic organizational hierarchy, wherein each security incident includes at least one of a security alert, an event and an anomaly;
prioritizing, at the prioritization analytics engine, each security incident that affects the critical asset accessed by the critical user;
identifying, at the prioritization analytics engine, at least one security incident when a critical user is affected by the security incident, wherein the security incident is selected from at least one of a security alert, a security event, and a security anomaly;
reporting, at the prioritization analytics engine, at least one of a security incident when there is a potential impact to at least one critical user; and
reporting, at the prioritization analytics engine, at least one security incident based on a potential impact to at least one critical asset.

10. The method of claim 9 wherein the social graph is generated with at least one email communication log.

11. The method of claim 9 wherein the first algorithm includes a betweenness algorithm.

12. The method of claim 9 further comprising identifying a critical asset community from a plurality of data sources and from the critical user accessing the data sources.

13. The method of claim 12 wherein the data sources include at least one network device accessing at least one of a firewall log and a router log.

14. A method for prioritizing a security incident, the method compromising:
determining, at a prioritization analytics engine, a dynamic organizational hierarchy;
applying, at the prioritization analytics engine, a first algorithm to the organizational hierarchy to produce a dynamic order of critical assets;
identifying, at a prioritization analytics engine, a critical asset community from a plurality of critical assets in the network;
prioritizing, at the prioritization analytics engine, a plurality of security incidents based on the dynamic order of critical assets, wherein each security incident includes at least one of a security alert, an event and an anomaly;
identifying, at the prioritization analytics engine, at least one security incident when a critical asset is affected by the security incident, wherein the security incident is selected from at least one of a security alert, a security event, and a security anomaly; and
reporting, at the prioritization analytics engine, at least one of a security incident when there is a potential impact on at least one critical asset.

15. The method of claim 14 wherein the dynamic order of critical assets is generated with network access logs and at least one dynamic organizational hierarchy.

16. The method of claim 14 wherein the first algorithm includes clustering and baselining algorithms using the access pattern of users weighted by hierarchy rank.

17. The method of claim 14 wherein the first algorithm includes a continuous baselining algorithm to determine the normal behavior of data flow, users, and servers.

18. The method of claim 14 further comprising identifying a critical asset community from a plurality of data sources and from the critical user accessing the data sources.

19. The method of claim 18 wherein the data sources include at least one network device accessing at least one of a firewall log and a router log.

20. The method of claim 19 further comprising prioritizing each security incident that affects the critical asset accessed by the critical user.

21. The method of claim 20 wherein the dynamic organization hierarchy is generated with a social graph.
